(19) United States
(12) Patent Application Publication
(10) Pub. No.: US 2010/0104067 A1
(43) Pub. Date: Apr. 29, 2010

(54) RADIOGRAPHIC IMAGING DEVICE

(75) Inventor: Yoshihiro OKADA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/604,374

(22) Filed: Oct. 22, 2009

(30) Foreign Application Priority Data
Oct. 24, 2008 (JP) 2008-274606

(51) Int. Cl. G01N 23/04

(52) U.S. Cl. 378/62

(57) ABSTRACT

The present invention provides radiographic imaging elements that can obtain a radiographic image by irradiation with radiation of different energies at a single time, while suppressing positional misalignment. Namely, radiographic imaging elements are disposed layered on one face-side of a support substrate. A signal detection circuit and a scan signal control circuit are disposed on the opposite face-side of the support substrate, these circuits performing at least one of control of detection and/or signal processing of image signals in the respective radiographic imaging elements. The signal detection circuit and the scan signal control circuit are connected to the respective radiographic imaging elements by connection lines, enabling communication.

### CROSS-REFERENCE TO RELATED APPLICATION

This application claims priority under 35 USC 119 from Japanese Patent Application No. 2008-274606, filed on Oct. 24, 2008, the disclosure of which is incorporated by reference herein.

### BACKGROUND OF THE INVENTION

1. Field of the Invention

The present invention relates to a radiographic imaging element. The present invention relates in particular to a radiographic imaging device that detects images representing irradiated radiation.

2. Description of the Related Art

Radiographic imaging devices using radiographic imaging elements such as FPDs (flat panel detectors), in which an X-ray sensitive layer is disposed on a TFT (thin film transistor) active matrix substrate and that can convert X-ray information directly into digital data, and the like, have been put into practice in recent years. Such radiographic imaging elements have the merit that, in comparison to with previous imaging plates, images can be more immediately checked and video images can also be checked. Consequently the introduction of radiographic imaging elements is proceeding rapidly.

Various types for such radiographic imaging elements are proposed. For example, there is a direct-conversion-type radiographic imaging elements that converts radiation, such as X-rays, directly into charges in a semiconductor layer, and accumulates the charges. Moreover, there is also indirect-conversion-type radiographic imaging elements that once converts radiation into light at a scintillator (wavelength converter), such as CsI:Tl, GOS (Gd₂O₂S:Tb) or the like, then converts the converted light into charges in sensor portions, such as photodiodes or the like, and accumulates the charges.

The following technique is known in the photographing of radiation images. By photographing the same region of a subject at different tube voltages, and carrying out image processing (hereinafter called “subtraction image processing”) that weights the radiation images obtained by the photographings at the respective tube voltages and computes the difference therebetween, a radiation image (hereinafter called “energy subtraction image”) is obtained in which one of an image portion, that corresponds to hard tissue such as bones or the like within the image, and an image portion, that corresponds to soft tissue, is emphasized and the other is removed. For example, when using an energy subtraction image that corresponds to soft tissue of the chest region, pathological changes that are hidden by the ribs can be seen. Accordingly, this technique can improve diagnostic performance.

When an energy subtraction image is desired by using analogue X-ray films or image plates, two sets of an X-ray sensitizing screen in close contact with an X-ray film, or two imaging plates, are superimposed on each other with a filter that absorbs a portion of any radiation interposed therebetween, and radiation is irradiated a single time. Subtraction image processing is then performed on the two radiographic images obtained with each of the X-ray films or each of the image plates. Due thereto, an energy subtraction image is obtained by using analogue X-ray films, or image plates, in this manner.

On the other hand, with a radiographic imaging element, there is proposed a method of photographing that, when an energy subtraction image is to be obtained, radiation of different energies are irradiated two times in succession with respect to a single radiographic imaging element, and two radiation images are obtained. Further, as shown in FIG. 26, with a radiographic imaging element, there is proposed a method in which two radiation images are obtained by irradiating radiation one time with two radiographic imaging elements superposed one on the other, similarly to the case of X-ray films or imaging plates.

In the former photographing method, the irradiation of X-rays is carried out twice. The amount of radiation to which the subject is exposed thereby increases. Further, in the former imaging method, the images become offset between the two times irradiation is carried out.

In the later imaging method however, in contrast to with X-ray films and image plates, read-out circuits at the periphery of the radiographic imaging elements, support substrates, and the like are required, as shown in FIG. 26. Therefore, the two radiographic imaging elements cannot be placed in close contact. Consequently, since radiation is irradiated in radial directions from a radiation source, the image size differs between each of the radiographic images obtained by the respective radiographic imaging elements.

Japanese Patent Application Laid-Open (JP-A) No. 2000-298198 discloses a technique of obtaining an energy subtraction image by layering plural individual radiation detecting layers and carrying out subtraction image processing on the radiation images obtained from the respective individual radiation detecting layers. In this case, correction of the pixel size is carried out so that the pixel sizes of the respective radiation images become the same.

However, any positional misalignment between respective radiographic images is preferably as small as possible when obtaining a radiographic image by radiation irradiation a single time with different energy radiation.

### SUMMARY OF THE INVENTION

The present invention provides a radiographic imaging device that can obtain a radiographic image by radiation irradiation a single time with different energy radiation, while suppressing any positional misalignment.

A first aspect of the present invention is a radiographic imaging device including: a support body of flat plate shape; plural radiographic imaging elements disposed layered at one face-side of the support body, each of the radiographic imaging elements detecting radiation irradiated thereon and outputting an image signal that represents a radiographic image according to an amount of the radiation; a control section, disposed at the opposite face-side of the support body, that performs at least one of control of detection in each of the plural radiographic imaging elements, and/or signal processing on the image signal; and connection lines that connect each of the respective plural radiographic imaging elements to the control section.

According to the first aspect of the present invention, the plural radiographic imaging elements are disposed layered at one face-side of the flat plate shaped support body, and the control section that performs at least one of control of detection in each of the plural radiographic imaging elements, and/or control of signal processing on the image signal, is disposed at the opposite face-side of the support body. Consequently, according to the first aspect of the present invention, the distance between the plural radiographic imaging elements can be shortened. This therefore means that the first aspect of the present invention can obtain a radiographic image by radiation irradiation a single time with different energy radiation, while suppressing any positional misalignment.

In a second aspect of the present invention, in the above-described aspect, one or more of the plural radiographic imaging elements may be back-front-reversed and layered.

In a third aspect of the present invention, in the above-described aspects, the plural radiographic imaging elements may each be formed in a rectangular plate shape, with a connection portion for connecting to the control section provided at each of two adjacent edges from the four edges of the radiographic imaging element, and one or more of the plural radiographic imaging elements rotated by 180° in the plane of the flat plate shape.

In a fourth aspect of the present invention, in the above-described aspects, the plural radiographic imaging elements may each be disposed with plural scan lines and plural signal lines that intersect with each other, with both ends of the lines exposed in at least one of the plural scan lines and/or the plural signal lines, and with connection portions for connecting to the control section formed at both ends.

In a fifth aspect of the present invention, in the above-described aspects, the plural radiographic imaging elements may each be disposed with plural scan lines and plural signal lines that intersect with each other, and with a connection portion for connection to the control section provided to at least one of the plural scan lines and/or the plural signal lines at a position that is not superimposed when the plural radiographic imaging elements are layered.

In a sixth aspect of the present invention, in the above-described aspects, the plural control sections may be provided corresponding to the plural radiographic imaging elements, with each of the control sections connected through the connection lines to the corresponding radiographic imaging element.

In a seventh aspect of the present invention, in the above-described aspects, the connection lines may be formed by a flexible printed substrate, with the control section provided on one face-side with a connector for connecting the connection lines, and with the control section(s) that correspond to the layered back-front-reversed radiographic imaging element(s) disposed back-front-reversed.

In a eighth aspect of the present invention, in the above-described aspects, the connection lines may be formed by a flexible printed substrate, with the control section provided on both front and back faces with a connector for connecting the connection lines.

In a ninth aspect of the present invention, in the above-described aspects, the control section may be provided on both front and back faces with an output terminal for outputting an image signal after the signal processing.

In a tenth aspect of the present invention, in the above-described aspects, the control section may be fixed directly to the support body, or fixed indirectly to the support body by a support member.

In a eleventh aspect of the present invention, in the above-described aspects, each of the plural radiographic imaging elements may be provided with a bonding layer on the face at the support body side, or on the face at the side of another radiographic imaging element, and fixed to one face of the support body by bonding.

In a twelfth aspect of the present invention, in the above-described aspects, the plural radiographic imaging elements may be detachably fixed to one face of the support body by a fixing member.

In a thirteenth aspect of the present invention, in the above-described aspects, a filter that absorbs radiation may also be provided, interposed between the plural radiographic imaging elements.

In a fourteenth aspect of the present invention, in the above-described aspects, the filter may be fixed to one or other of the radiographic imaging elements the filter makes contact with.

In a fifteenth aspect of the present invention, in the above-described aspects, the radiographic imaging elements may also include a light generation section that generates light according to the radiation irradiated thereon, a sensor section that generates charge according to illumination thereon of light generated by the light generation section, and a light blocking body that blocks light generated by the light generation section and is provided on the opposite face-side of the radiographic imaging element.

In a sixteenth aspect of the present invention, in the above-described aspects, the light blocking body may be configured by a light generation section support body that supports the light generation section.

In a seventeenth aspect of the present invention, in the above-described aspects, the plural radiographic imaging elements may have the same array pattern of pixel portions that detect radiation as data, for pixels configuring each respective radiographic image.

The radiographic imaging device of the present invention, due to the above aspects, can obtain a radiographic image by radiation irradiation a single time with different energy radiation, while suppressing positional misalignment.

### BRIEF DESCRIPTION OF THE DRAWINGS

Exemplary embodiments of the present invention will be described in detail based on the following figures, wherein:

FIG. 1 is a schematic configuration diagram according to a first exemplary embodiment showing a detailed configuration of a radiographic imaging element and a control section that drives the radiographic imaging element;

FIG. 2 is a plan view of an imaging section according to the first exemplary embodiment, as seen from one face-side thereof;

FIG. 3 is a plan view of the imaging section according to the first exemplary embodiment, as seen from the opposite face-side thereof;

FIG. 4 is a cross-sectional view of the A-A line in the imaging section according to the first exemplary embodiment;

FIG. 5 is a diagram showing the placement arrangement of the radiographic imaging elements according to a first exemplary embodiment;

FIG. 6 is a plan view as seen from one face-side of an imaging section according to a second exemplary embodiment;

FIG. 7 is a plan view as seen from the opposite face-side of the imaging section according to the second exemplary embodiment;

FIG. 8 is a cross-sectional view of the A-A line in the imaging section according to the second exemplary embodiment;

FIG. 9 is a diagram showing the placement arrangement of radiographic imaging elements according to the second exemplary embodiment;

FIG. 10 is a plan view as seen from one face-side of an imaging section according to a third exemplary embodiment;

FIG. 11 is a plan view as seen from the opposite face-side of the imaging section according to the third exemplary embodiment;

FIG. 12 is a cross-sectional view of the A-A line in the imaging section according to the third exemplary embodiment;

FIG. 13 is a cross-sectional view of the B-B line in the imaging section according to the third exemplary embodiment;

FIG. 14 is a diagram showing the placement arrangement of radiographic imaging elements according to the third exemplary embodiment;

FIG. 15 is a cross-sectional view showing the configuration of an imaging section according to another exemplary embodiment;

FIG. 16 is a cross-sectional view showing the configuration of an imaging section according to another exemplary embodiment;

FIG. 17 is a configuration diagram showing the detailed configuration of a radiographic imaging element according to a fourth exemplary embodiment;

FIG. 18 is a plan view as seen from one face-side of an imaging section according to the fourth exemplary embodiment;

FIG. 19 is a plan view as seen from the opposite face-side of the imaging section according to the fourth exemplary embodiment;

FIG. 20 is a cross-sectional view of the A-A line in the imaging section according to the fourth exemplary embodiment;

FIG. 21 is a diagram showing the placement arrangement of radiographic imaging elements according to the fourth exemplary embodiment;

FIG. 22 is a cross-sectional view showing the configuration of an imaging section according to another exemplary embodiment;

FIG. 23 is a cross-sectional view showing the configuration of an imaging section according to another exemplary embodiment;

FIG. 24 is a configuration diagram showing the configuration of a radiographic imaging element according to another exemplary embodiment;

FIG. 25 is a cross-sectional view showing a configuration of an imaging section according to another exemplary embodiment; and

FIG. 26 is cross-sectional view showing a configuration of a related art imaging section.

### DETAILED DESCRIPTION OF THE INVENTION

The present invention as applied to a radiographic imaging device 100 that captures radiographic images of radiation, such as X-rays or the like, will now be explained with reference to the drawings.

### First Exemplary Embodiment

Explanation will first be given of a radiographic imaging element 10 employed in the radiographic imaging device 100 according to the first exemplary embodiment.

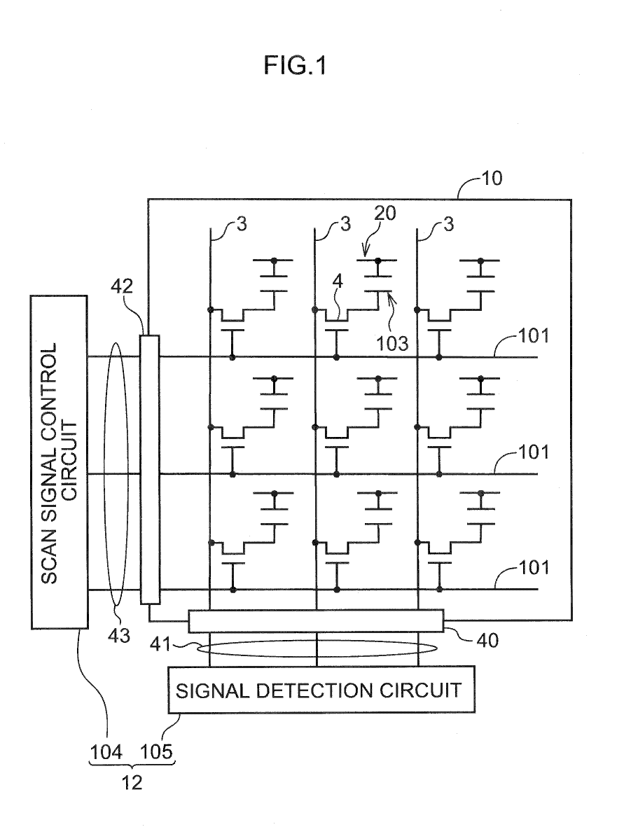

A detailed configuration according to the first exemplary embodiment, of the radiographic imaging element 10 and a control section 12 that drives the radiographic imaging element 10, is shown in FIG. 1.

The radiographic imaging element 10 is provided with plural pixels 20 disposed in a two-dimensional array. Each of the pixels 20 is configured to include: a sensor portion 103, including an upper electrode, a semiconductor layer, and a lower electrode; and a TFT switch 4. The sensor portion 103 receives light and accumulates charge. The TFT switch 4 reads out the charge that has accumulated in the sensor portion 103.

Plural scan lines 101 and plural signal lines 3 are provided in the radiographic imaging element 10 so as to intersect with each other. The scan lines 101 switch the TFT switches 4 ON/OFF. The charge accumulated in the sensor portions 103 is read out through the signal lines 3.

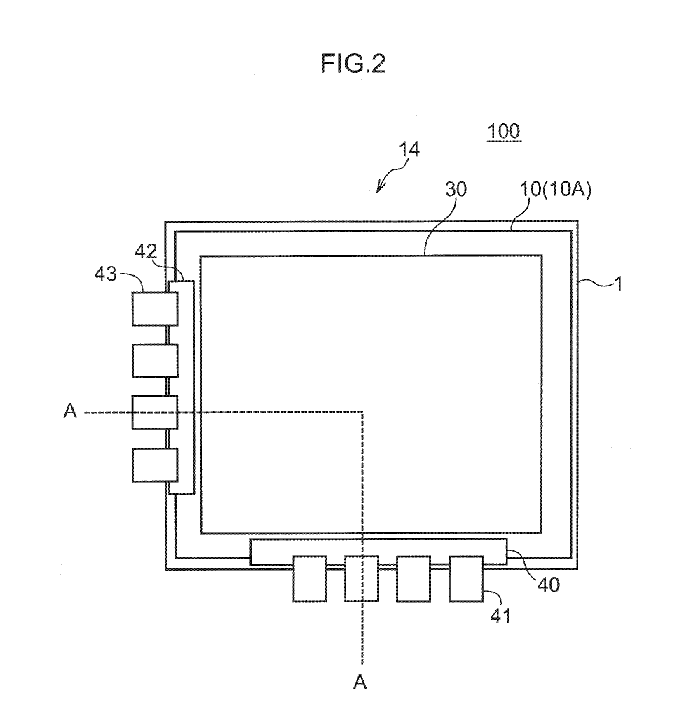

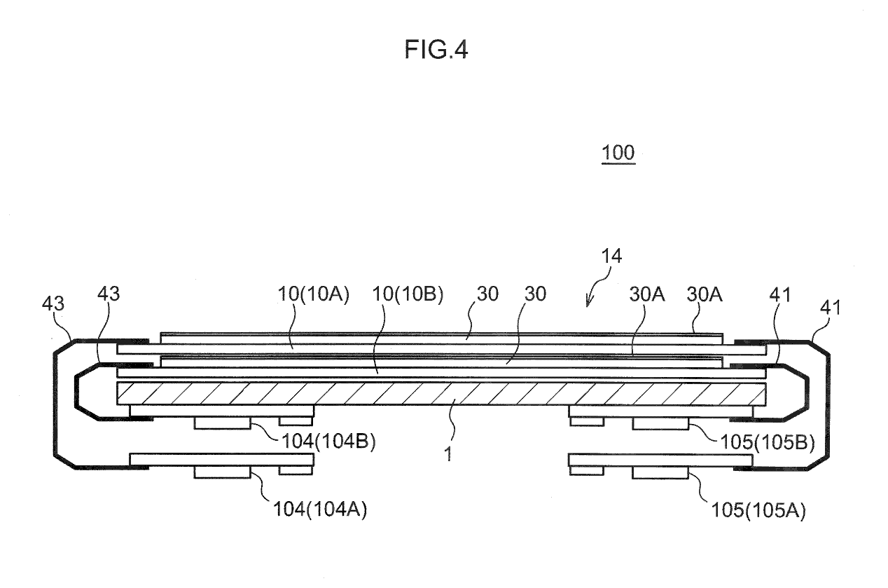

A scintillator 30 (see FIG. 2 and FIG. 4) made from a GOS or the like, is applied to the surface of the radiographic imaging element 10 according to the first exemplary embodiment. In order to prevent external leakage of generated light, there is a light-blocking body 30A at the opposite face of the scintillator 30 to that applied to the radiographic imaging element 10, the light-blocking body 30A blocking generated light. The light-blocking body 30A may jointly serve as a light generation section support body that supports the scintillator 30. The need to separately provide a member to support the scintillator 30 is removed by configuring the light-blocking body 30A to jointly serve as the light generation section support body supporting the scintillator 30.

In the radiographic imaging element 10, irradiated radiation, such as X-rays or the like, is converted into light in the scintillator 30, and is illuminated onto the sensor portion 103. The sensor portion 103 receives the illuminated light from the scintillator 30 and accumulates charges.

An electrical signal (image signal), representing a radiographic image according to the charge amount accumulated in the respective sensor portions 103, flows in each of the respective signal lines 3 when whichever of the TFT switches 4 that is connected to the given signal line 3 is switched ON.

A connector 40 is provided at one end of the radiographic imaging element 10 in the signal line direction. A connector 42 is provided at one end of the radiographic imaging element 10 in the scan line direction. Each of the signal lines 3 is connected to the connector 40. Further, each of the scan lines 101 is connected to the connector 42.

The control section 12 is provided in the first exemplary embodiment to control detection of radiation by the radiographic imaging element 10 and to control signal processing to the electrical signal flowing in each of the signal lines 3. The control section 12 is equipped with a signal detection circuit 105 and a scan signal control circuit 104.

The signal detection circuit 105 is connected to the connector 40 via connection lines 41. Further, the signal detection circuit 105 is installed with an amplifier circuit for each of the respective signal lines 3, and the amplifier circuits amplify the inputted electrical signals. In the signal detection circuit 105, electrical signals inputted by each of the signal lines 3 are amplified by the amplifier circuits and is detected. The signal detection circuit 105 thereby detects the charge amount that has accumulated in each of the sensor portions 103 as data for each of the pixels 20 configuring an image.

The scan signal control circuit 104 is connected to the connector 42 via connection lines 43. The scan signal control circuit 104 outputs a control signal to each of the scan lines 101 for switching the respective TFT switch 4 ON/OFF.

Explanation will now be given of the radiographic imaging device 100 according to the first exemplary embodiment.

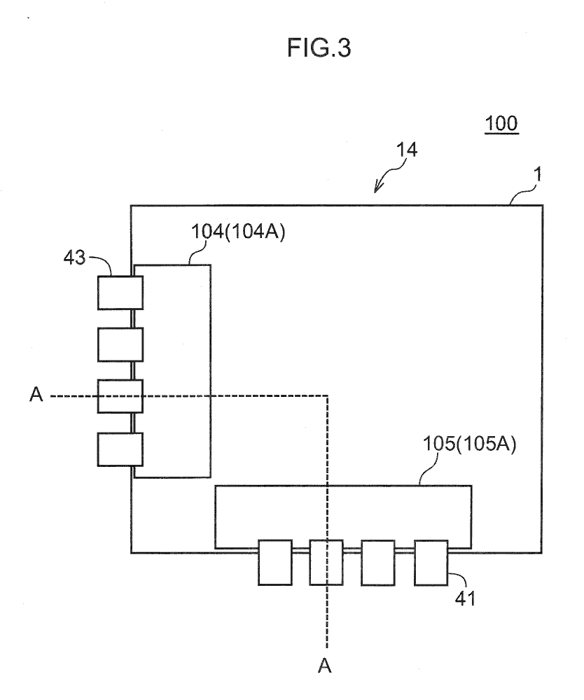

The configuration of the radiographic imaging device 100 according to the first exemplary embodiment is shown in FIG. 2 to FIG. 4. A plan view as seen from one face-side of an imaging section 14 according to the first exemplary embodiment is shown in FIG. 2. A plan view as seen from the opposite face-side of the imaging section 14 according to the first exemplary embodiment is shown in FIG. 3. A cross-sectional view of the A-A line of FIG. 2 and FIG. 3 is shown in FIG. 4.

The radiographic imaging device 100 according to the first exemplary embodiment captures a radiographic image representing irradiated radiation, and includes the imaging section 14.

The imaging section 14 has two radiographic imaging elements 10 disposed layered at one face-side of a support substrate 1, which is formed as a flat plate shape, and, corresponding to each of the radiographic imaging elements 10, there are a signal detection circuit 105 and a scan signal control circuit 104 disposed at the opposite face-side of the support substrate 1. Note that, since the two radiographic imaging elements 10 are superimposed on each other in the first exemplary embodiment, only the radiographic imaging element 10 on the top side is shown in FIG. 2. In addition, because the two signal detection circuits 105 and scan signal control circuits 104 are superimposed on each other, only the signal detection circuit 105 and the scan signal control circuit 104 at the bottom side are shown in FIG. 3.

In order to discriminate between the two radiographic imaging elements 10, they will be referred to as radiographic imaging elements 10A, 10B herebelow. Further, in order to discriminate between the two signal detection circuits 105 and scan signal control circuits 104 those corresponding to the radiographic imaging element 10A will be referred to as signal detection circuit 105A and scan signal control circuit 104A, and those corresponding to the radiographic imaging element 10B as signal detection circuit 105B and scan signal control circuit 104B.

The radiographic imaging element 10A has a bonding layer on the face thereof at the radiographic imaging element 10B side. The radiographic imaging element 10B has a bonding layer on both the face thereof at the support substrate 1 side and the face thereof at the radiographic imaging element 10A side. The radiographic imaging element 10B is fixed by bonding to one face of the support substrate 1.

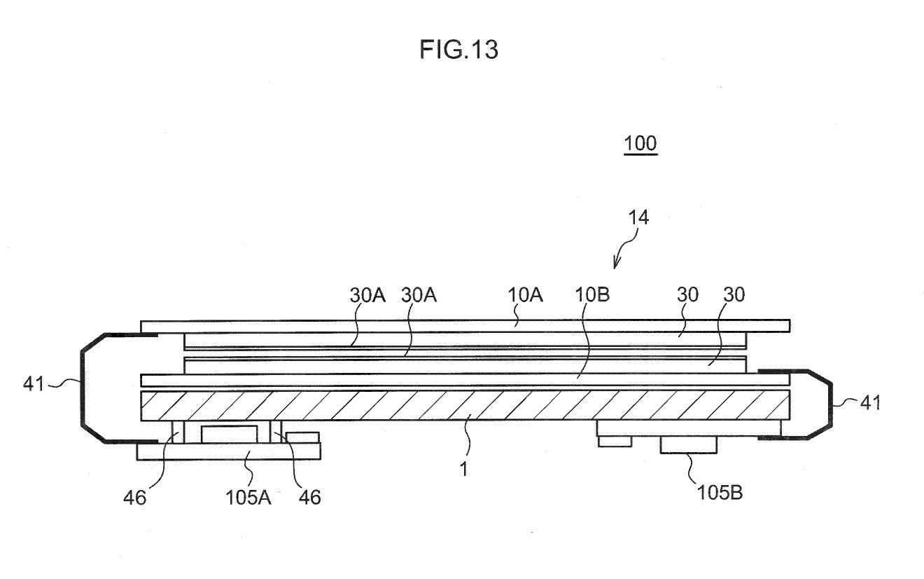

The signal detection circuit 105B and the scan signal control circuit 104B are directly fixed to the support substrate 1. The signal detection circuit 105A and the scan signal control circuit 104A are indirectly fixed to the support substrate 1 via support members 46 (see FIG. 13).

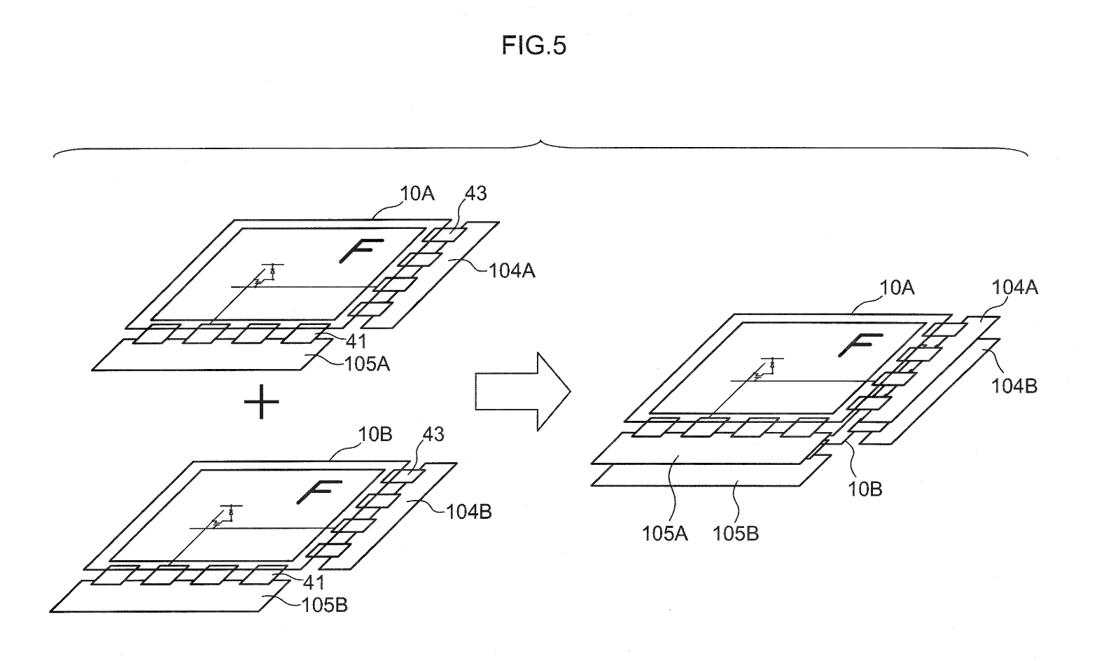

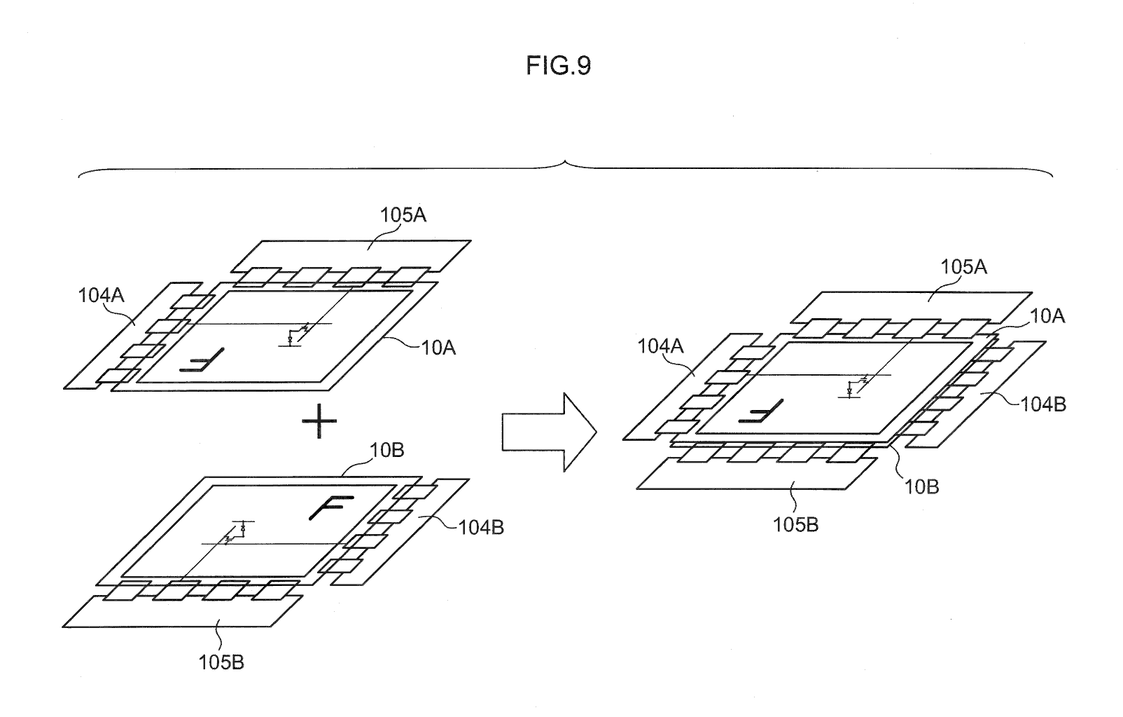

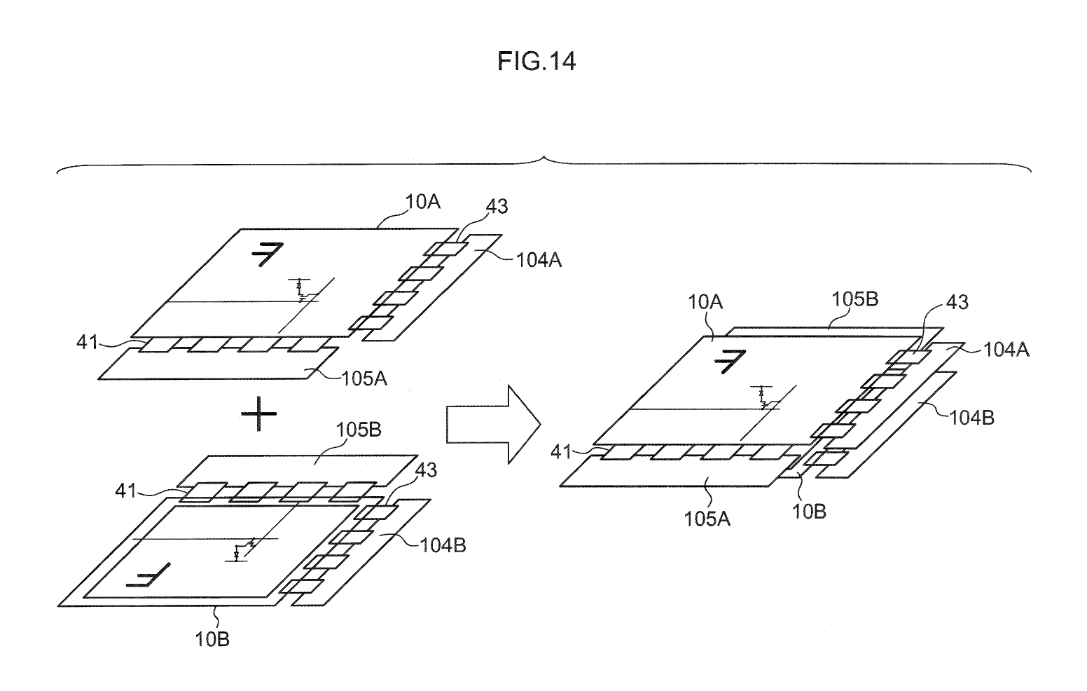

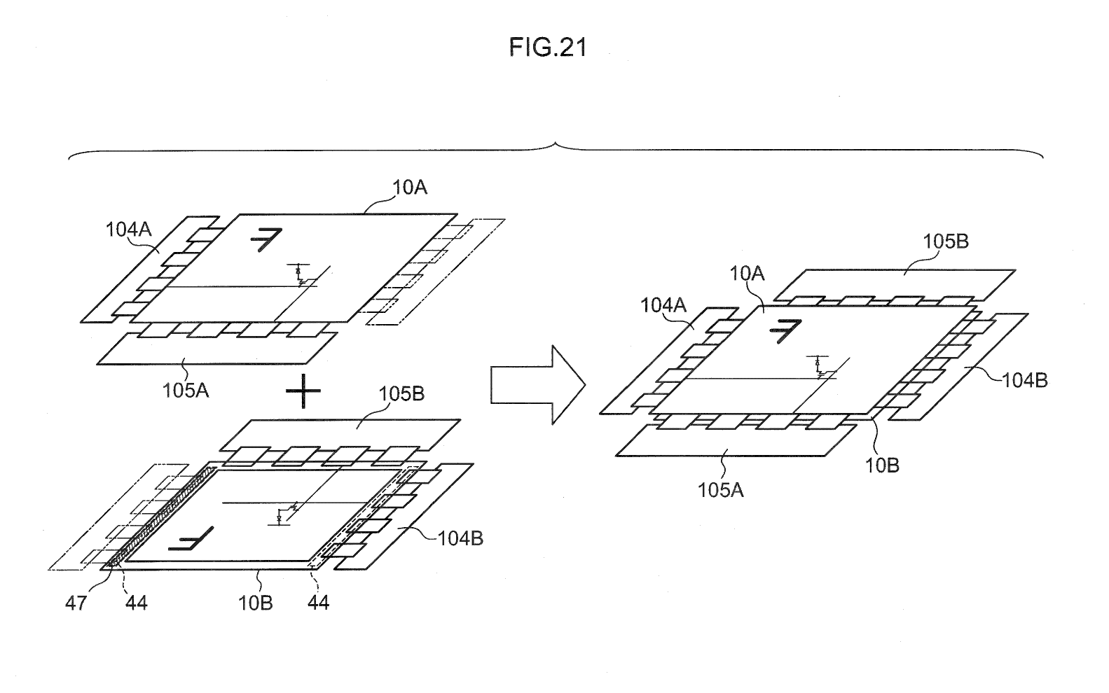

In the first exemplary embodiment, when the radiographic imaging elements 10A, 10B are layered, they are superimposed on each other, both facing in the same direction and with the same rotational orientation, as shown in FIG. 5. In FIG. 5, and in later described FIG. 9, FIG. 14 and FIG. 21, the letter “F” has been appended to the top face of the radiographic imaging elements 10, so as to indicate the facing direction and rotational orientation of the radiographic imaging elements 10A, 10B.

Accordingly, the radiographic imaging elements 10 are layered with the same facing direction and same rotational orientation. Therefore, in the imaging section 14 according to the first exemplary embodiment, the signal detection circuits 105 and scan signal control circuits 104 corresponding to the respective radiographic imaging elements 10 are disposed in positions where they superimpose.

The connector 40 and the signal detection circuit 105A of the radiographic imaging element 10A are mutually connected together by the connection lines 41. Further, the connector 40 and the signal detection circuit 105B of the radiographic imaging element 10B are mutually connected together by the connection lines 41. In addition, the connector 42 and the scan signal control circuit 104A of the radiographic imaging element 10A are mutually connected together by connection lines 43. The connector 42 and the scan signal control circuit 104B of the radiographic imaging element 10B are mutually connected together by the connection lines 43. In the first exemplary embodiment, the connection lines 41 and the connection lines 43 are of flexible wiring, formed by a flexible printed substrate.

Explanation will now be given of operation of the radiographic imaging device 100 according to the first exemplary embodiment.

In the radiographic imaging device 100, when imaging, for example, an X-ray image, X-rays that have passed through an imaging subject are irradiated onto the imaging sections 14 in the radiographic imaging elements 10. The X-rays that have passed through the imaging subject include high energy components and low energy components.

In the imaging sections 14 the radiographic imaging elements 10A, 10B are disposed layered on each other at one face-side of the support substrate 1, as shown in FIG. 4. Therefore, the low energy X-rays are absorbed in the radiographic imaging element 10A and do not reach the radiographic imaging element 10B, and a portion of the high energy X-rays are absorbed in the radiographic imaging element 10A. However, the remaining portion of the high energy X-rays passes through the radiographic imaging element 10A and reaches the radiographic imaging element 10B. Due to the above, the radiographic imaging element 10A has sensitivity to the low energy and high energy X-rays. The radiographic imaging element 10B has sensitivity to high energy X-rays.

Charges are generated due to X-ray irradiation in each of the sensor portions 103 in the radiographic imaging elements 10A, 10B.

When reading out images, an ON signal (+10 to 20V) is sequentially applied from the scan signal control circuits 104A, 104B to the gate electrodes of the TFT switches 4 of the radiographic imaging elements 10A, 10B, via the scan lines 101. The TFT switches 4 of the radiographic imaging elements 10A, 10B are thereby sequentially switched ON. Due to this, an electrical signal corresponding to the charge amount accumulated in the sensor portion 103 flows out in the signal lines 3. The signal detection circuits 105A, 105B, based on the electrical signal flowing out in the signal lines 3 of the radiographic imaging elements 10A, 10B, detects the charge amount accumulated in each of the sensor portions 103, as a data for each of the pixels 20 configuring an image. The radiographic imaging device 100 can thereby obtain image data representing an image that shows the radiation irradiated onto the radiographic imaging elements 10A, 10B.

In the radiographic imaging element 10 according to the first exemplary embodiment, there are two radiographic imaging elements 10 disposed layered at one face-side of the support substrate 1, and the signal detection circuits 105 and the scan signal control circuits 104 of the respective radiographic imaging elements 10 are disposed on the opposite face-side of the support substrate 1.

Accordingly, in the first exemplary embodiment there are two sheets of radiographic imaging elements 10 disposed layered at one face-side of the support substrate 1. In the first exemplary embodiment the separation distance between each of the radiographic imaging elements 10 can thereby be made small. Consequently the first exemplary embodiment can suppress to a small amount difference in the image size of each of the radiographic images obtained from the respective radiographic imaging elements 10.

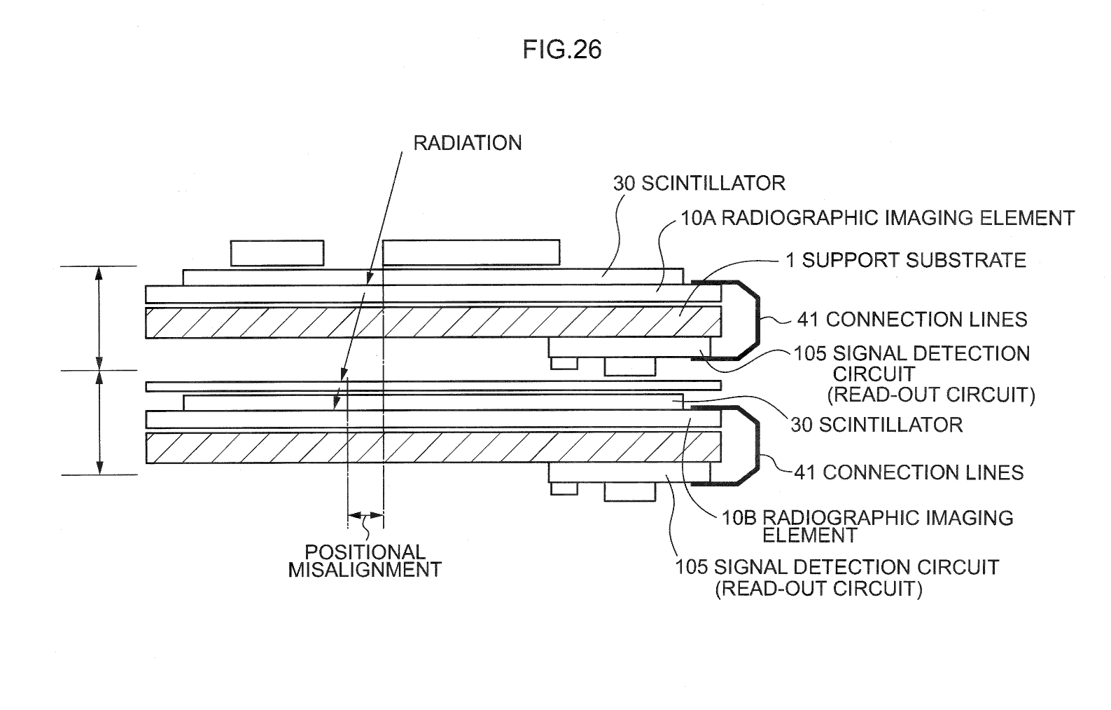

Further, according to the first exemplary embodiment, the signal detection circuits 105 and the scan signal control circuits 104 of the radiographic imaging elements 10 are disposed on the opposite face-side of the support substrate 1. Consequently, the first exemplary embodiment can have a thinner imaging section 14, in comparison to cases where the signal detection circuits 105 and the scan signal control circuits 104 are provided to separate support substrates 1 and then stacked, as shown in FIG. 26.

Furthermore, in the first exemplary embodiment, the signal detection circuits 105 and the scan signal control circuits 104 are disposed on the opposite face-side of the support substrate 1. Therefore radiation is absorbed by the support substrate 1. Consequently, in the first exemplary embodiment the signal detection circuits 105 and the scan signal control circuits 104 can be protected from radiation.

### Second Exemplary Embodiment

Explanation will now be given of a second exemplary embodiment.

The configuration of the radiographic imaging elements 10 according to the second exemplary embodiment is similar to those of the above first exemplary embodiment (see FIG. 1) and explanation thereof will therefore be omitted.

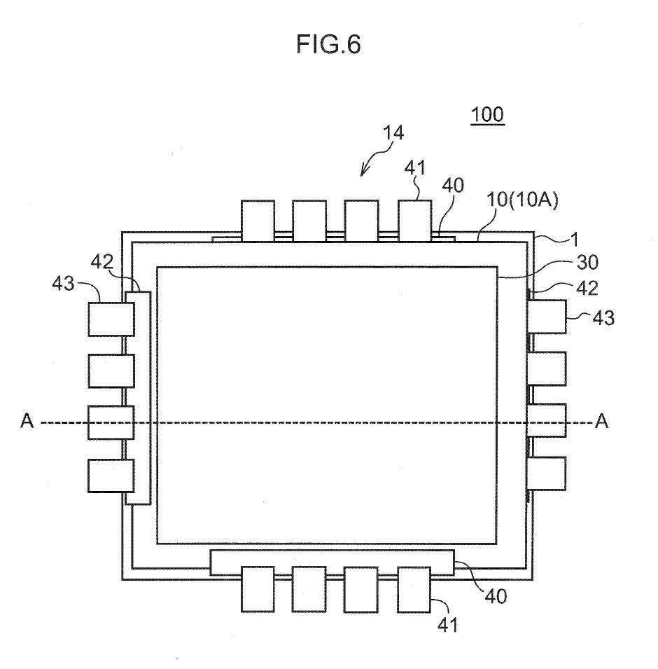

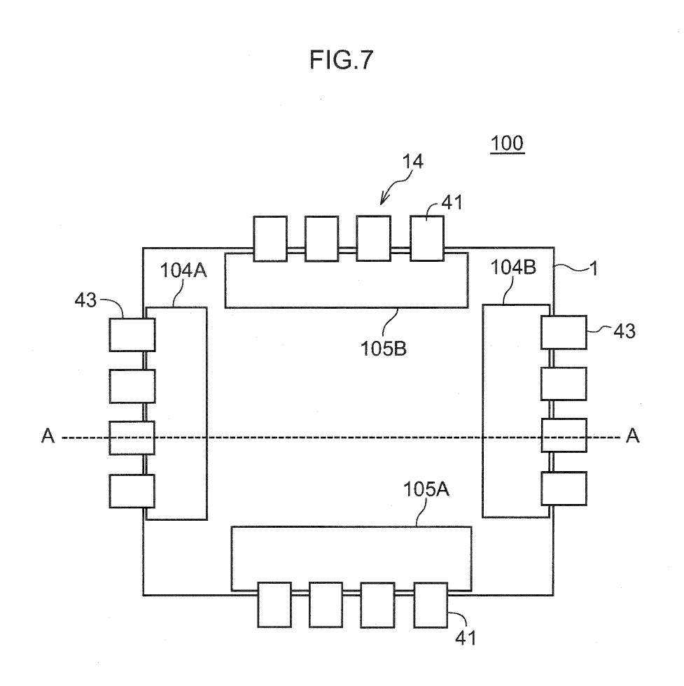

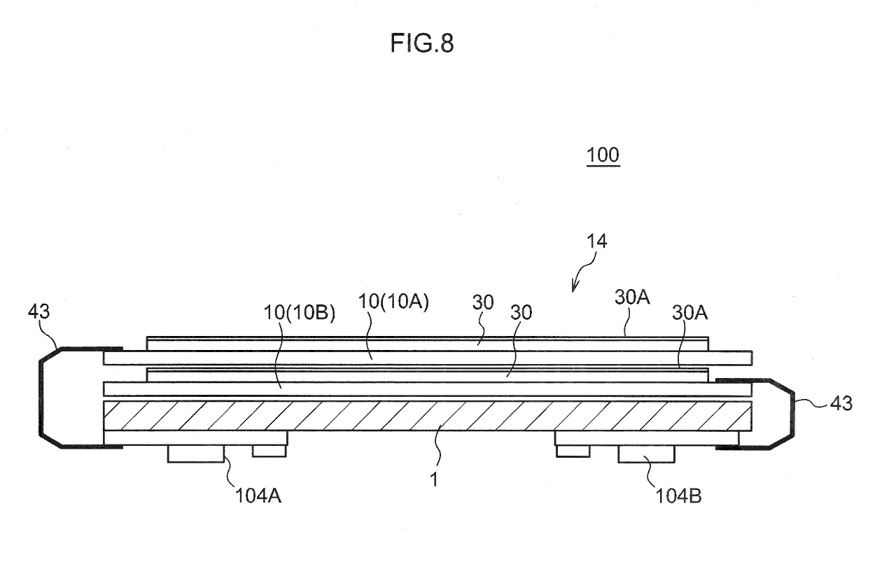

A configuration of a radiographic imaging device 100 according to the second exemplary embodiment is shown in FIG. 6 to FIG. 8. A plan view as seen from one face-side of an imaging section 14 according to the second exemplary embodiment is shown in FIG. 6. A plan view as seen from the opposite face-side of the imaging section 14 according to the second exemplary embodiment is shown in FIG. 7. A cross-sectional view of the A-A line of FIG. 6 and FIG. 7 is shown in FIG. 8. Portions that are similar to those of the above first exemplary embodiment (see FIG. 2 to FIG. 4) are allocated the same reference numerals, and explanation thereof is omitted.

In the imaging section 14 according to the second exemplary embodiment, the radiographic imaging elements 10A, 10B are disposed layered at one face-side of a support substrate 1 that is formed in a flat plate shape. In the imaging section 14 according to the second exemplary embodiment, the signal detection circuits 105A, 105B and the scan signal control circuits 104A, 104B of the radiographic imaging elements 10 are disposed on the opposite face-side of the support substrate 1.

In the second exemplary embodiment, when the two radiographic imaging elements 10 are layered, as shown in FIG. 9, one of the radiographic imaging elements 10 is rotated by 180° in the plane of the flat plate-shaped radiographic imaging element 10. In the second exemplary embodiment the radiographic imaging element 10A is rotated by 180° in the plane thereof and then superimposed.

According to the second exemplary embodiment as described above, one of the two radiographic imaging elements 10 is rotated by 180° with respect to the other and then layered. Consequently, in the imaging section 14 according to the second exemplary embodiment the signal detection circuits 105 and the scan signal control circuits 104 of each of the radiographic imaging elements 10 are disposed in non-superimposed positions. Accordingly, the thickness of the imaging section 14 according to the second exemplary embodiment can thereby be made even thinner.

### Third Exemplary Embodiment

Explanation will now be given of a third exemplary embodiment.

The configuration of the radiographic imaging element 10 according to the third exemplary embodiment is similar to that of the above first exemplary embodiment (see FIG. 1) and explanation thereof will therefore be omitted.

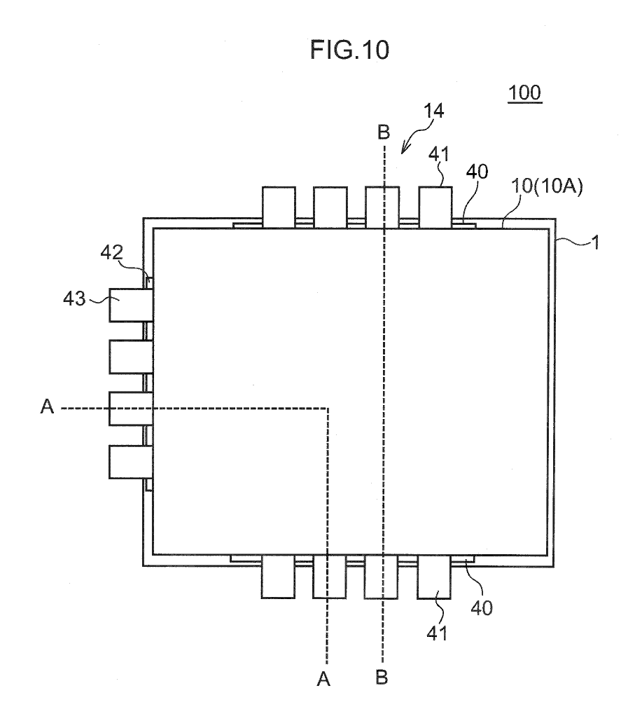

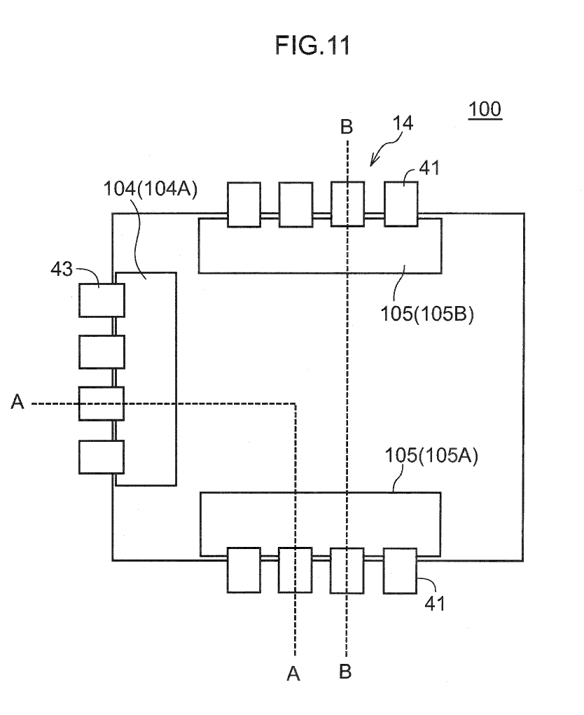

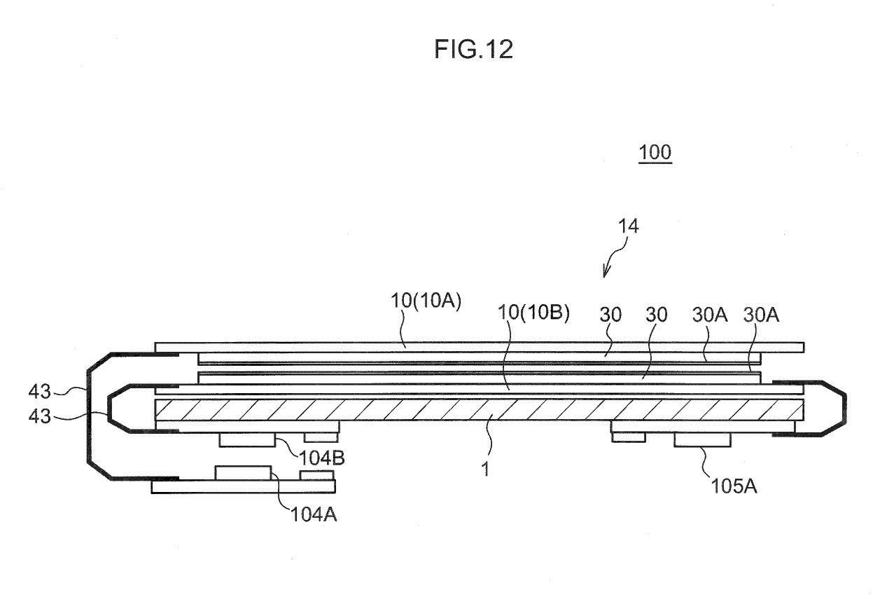

A configuration of a radiographic imaging device 100 according to the third exemplary embodiment is shown in FIG. 10 to FIG. 13. A plan view as seen from one face-side of an imaging section 14 according to the third exemplary embodiment is shown in FIG. 10. A plan view as seen from the opposite face-side of the imaging section 14 according to the third exemplary embodiment is shown in FIG. 11. A cross-sectional view of the A-A line of FIG. 10 and FIG. 11 is shown in FIG. 12. A cross-sectional view of the B-B line of FIG. 10 and FIG. 11 is shown in FIG. 13. Portions that are similar to those of the above first exemplary embodiment (see FIG. 2 to FIG. 4) are allocated the same reference numerals, and explanation thereof is omitted. Since the scan signal control circuits 104 are superimposed on each other in the third exemplary embodiment, only the scan signal control circuit 104 at the topside is shown in FIG. 11.

In the imaging section 14 according to the third exemplary embodiment, the radiographic imaging elements 10A, 10B are disposed layered at one face-side of a support substrate 1 that is formed in a flat plate shape. The signal detection circuits 105A, 105B and the scan signal control circuits 104A, 104B of the radiographic imaging elements 10 are disposed on the opposite face-side of the support substrate 1.

In the third exemplary embodiment, when the two radiographic imaging elements 10 are layered, the front and back faces of one of the radiographic imaging element 10 are reversed before stacking, as shown in FIG. 14. In the third exemplary embodiment the radiographic imaging element 10A is superimposed with its front and back faces reversed.

By so doing, according to the third exemplary embodiment, one of the two radiographic imaging elements 10 is layered with its front and back faces reversed with respect to the other. Therefore, in the imaging section 14 according to the third exemplary embodiment, either the signal detection circuits 105 or the scan signal control circuits 104 of the radiographic imaging elements 10 are disposed in a superimposed position, with the other disposed in a non-superimposed position. Consequently, the third exemplary embodiment of the present invention can reduce the thickness of the imaging section 14, in comparison to cases where the signal detection circuits 105 and the scan signal control circuits 104 are provided as the control section 12 of the radiographic imaging element 10 on separate support substrates 1 and then stacked, as shown in FIG. 26.

It should be noted that, the back-front-reversed radiographic imaging element 10A according to the third exemplary embodiment, as shown in FIG. 12 and FIG. 13, may be configured with the signal detection circuit 105A and the scan signal control circuit 104A reversed. In another exemplary embodiment, the signal detection circuit 105 and the scan signal control circuit 104 that have been back-front-reversed may also be indirectly fixed to the support substrate 1 via support members 46. In the third exemplary embodiment, as shown in FIG. 13, the signal detection circuit 105A is indirectly fixed to the support substrate 1. By so doing the radiographic imaging elements 10A, 10B are able to utilize the same signal detection circuits 105 and scan signal control circuits 104.

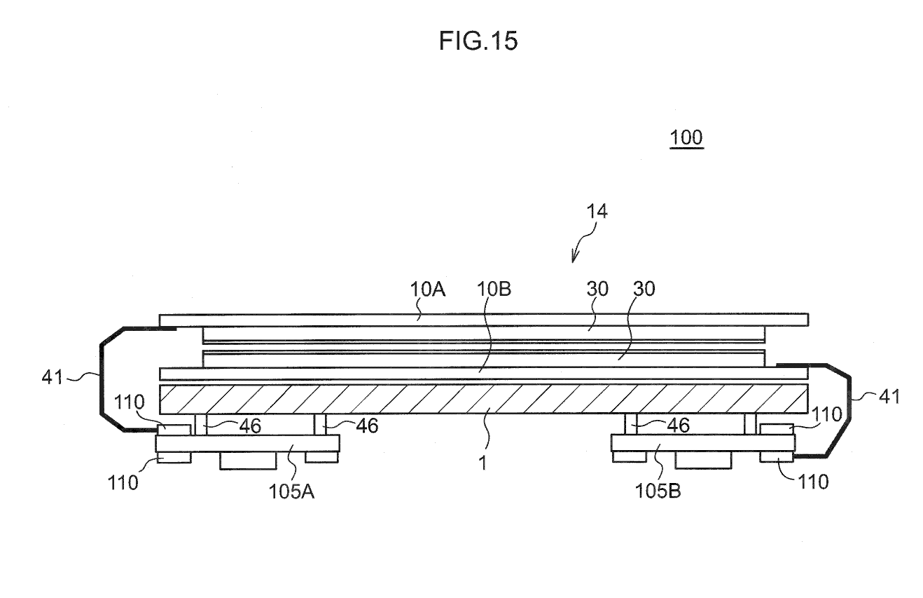

Note that in another exemplary embodiment, connectors for connecting the connection lines 41 and the connection lines 43 to the signal detection circuits 105 and the scan signal control circuits 104 may be provided at the two faces, front and back. In FIG. 15, an example is shown in which connectors 110 are provided to the two faces, front and back, of the signal detection circuits 105A, 105B for connecting the connection lines 41. By so doing, in this another exemplary embodiment, even when the front and back of the signal detection circuit 105 have been reversed, one or other of the connectors 110 is on the front face side. Consequently, the connection lines 41 are more readily connected to the connector 110 in this other exemplary embodiment.

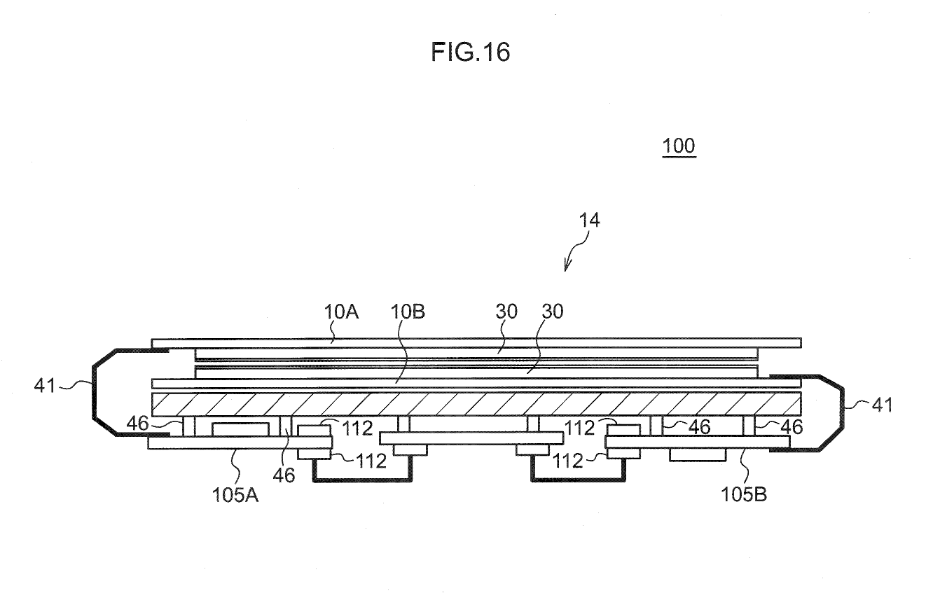

In another exemplary embodiment, connectors may be provided on both of the two faces, front and rear, in order to connect another circuit, such as a control section for controlling operation of the signal detection circuits 105 and the scan signal control circuits 104. An example is shown in FIG. 16 in which connectors 112 for connection to another circuit, such as a control section, are provided on the two faces, front and rear, of the signal detection circuits 105A, 105B. By so doing, even when the front and back of the signal detection circuit 105 have been reversed, one or other of the connectors 112 is on the front face. Consequently, the signal detection circuits 105 are more readily connected to another circuit in this other exemplary embodiment.

### Fourth Exemplary Embodiment

Explanation will now be given of a fourth exemplary embodiment.

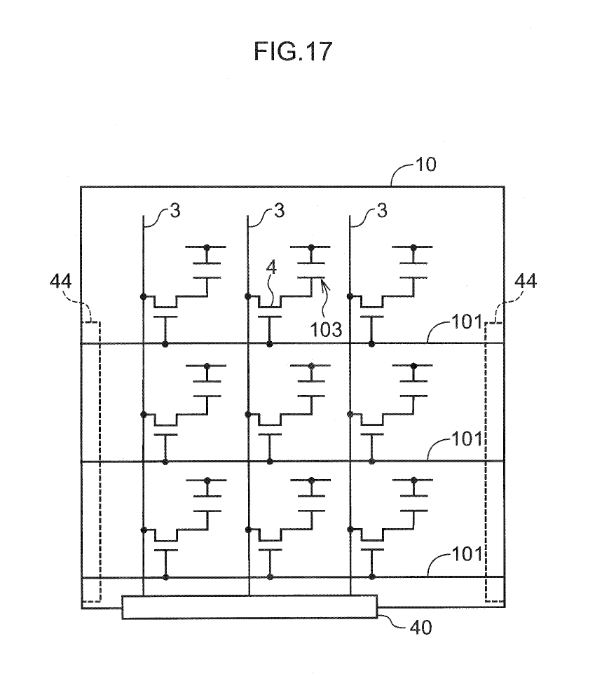

A detailed configuration of a radiographic imaging element 10 according to the fourth exemplary embodiment is shown in FIG. 17. Portions that are similar to those of the above first exemplary embodiment (see FIG. 1) are allocated the same reference numerals, and explanation thereof is omitted.

In the radiographic imaging element 10 according to the fourth exemplary embodiment, exposed regions 44 are provided at both end portions of each of the scan lines 101, through which the scan lines 101 are exposed. In the fourth exemplary embodiment, connectors 42 are formable to each of the exposed regions 44 at the two ends in the scan line direction.

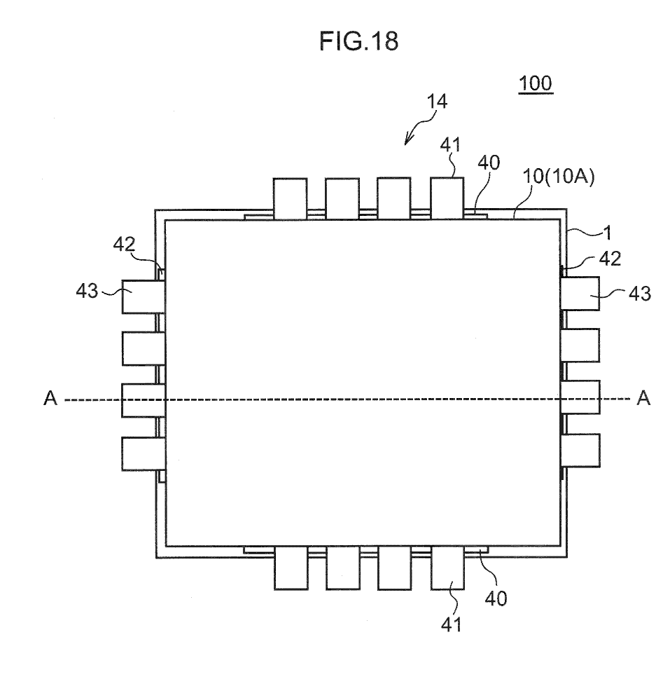

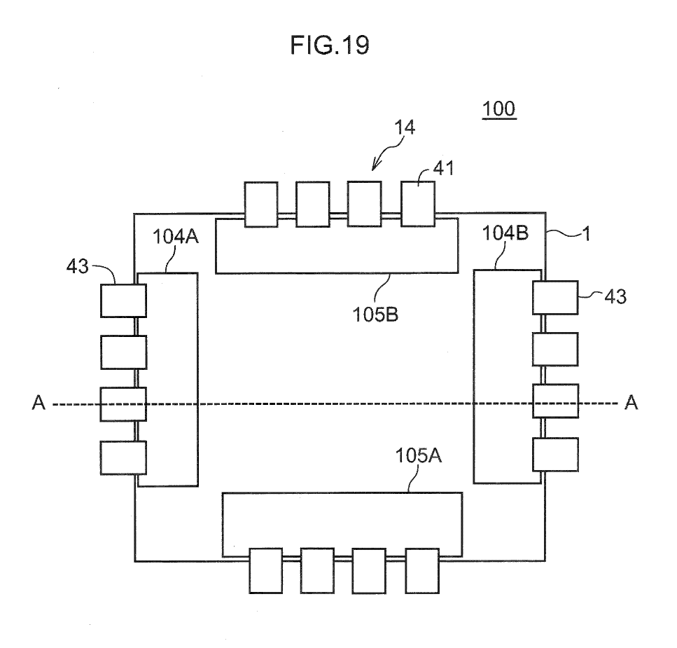

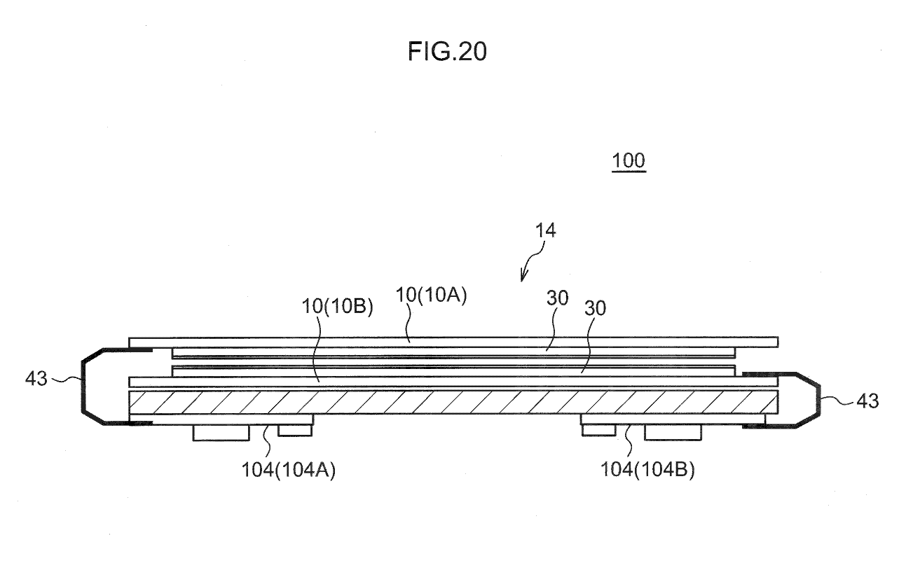

A configuration of a radiographic imaging device 100 according to the fourth exemplary embodiment is shown in FIG. 18 to FIG. 20. It should be noted that, a plan view as seen from one face-side of an imaging section 14 according to the fourth exemplary embodiment is shown in FIG. 18. A plan view as seen from the opposite face-side of the imaging section 14 according to the fourth exemplary embodiment is shown in FIG. 19. A cross-sectional view of the A-A line of FIG. 18 and FIG. 19 is shown in FIG. 20. Portions that are similar to those of the above first exemplary embodiment (see FIG. 2 to FIG. 4) are allocated the same reference numerals, and explanation thereof is omitted.

In the imaging section 14 according to the fourth exemplary embodiment, the radiographic imaging elements 10A, 10B are disposed layered at one face-side of a support substrate 1 that is formed in a flat plate shape. In the imaging section 14 according to the fourth exemplary embodiment, the signal detection circuits 105A, 105B and the scan signal control circuits 104A, 104B of the radiographic imaging elements 10 are disposed on the opposite face-side of the support substrate 1.

In the fourth exemplary embodiment, when the two radiographic imaging elements 10 are layered, the front and back of one of the radiographic imaging element 10 are reversed and then layered, as shown in FIG. 21. In the fourth exemplary embodiment the front and back of the radiographic imaging element 10A are reversed and then superimposed.

When the two radiographic imaging elements 10 are layered with one of the radiographic imaging elements 10 back-front-reversed with respect to the other, the scan signal control circuits 104 are disposed in a superimposed position. In the fourth exemplary embodiment, as shown in FIG. 21, connectors 42 are formable to both ends of the radiographic imaging elements 10A, 10B in the scan line direction. Therefore, in the fourth exemplary embodiment, the position provided with the connectors 42 is changeable such that the connectors 42 are not superimposed on each other when the radiographic imaging elements 10A, 10B are layered. By so doing, in the fourth exemplary embodiment, the scan signal control circuits 104 are disposed in non-superimposed positions. Due thereto, from the standpoint of noise reduction and the like, the exposed region 44 of the radiographic imaging element 10 not provided with the connector 42 is preferably insulated by an insulating member 47.

Thereby, according to the fourth exemplary embodiment, the signal detection circuits 105 and the scan signal control circuits 104 corresponding to the respective radiographic imaging elements 10 are disposed in non-superimposed positions. Consequently, the thickness of the imaging section 14 can be reduced in the fourth exemplary embodiment.

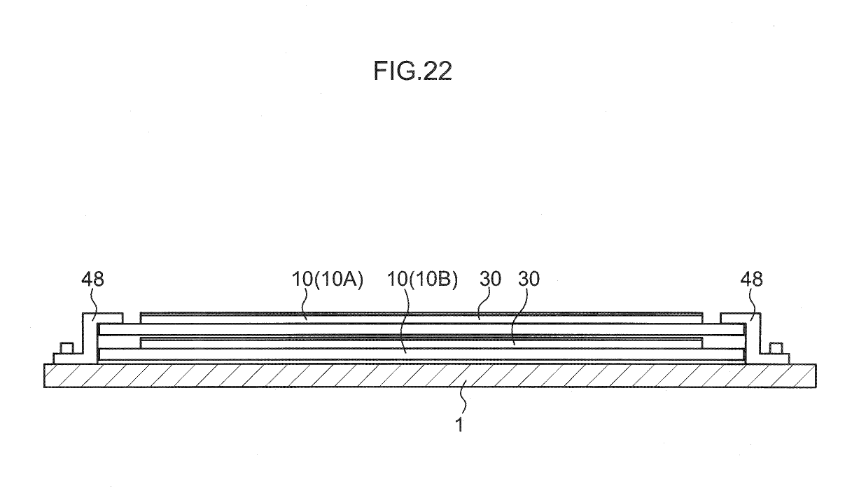

In each of the above exemplary embodiments, explanation has been given of cases where the radiographic imaging element 10A and the radiographic imaging element 10B are fixed to the opposite side of the support substrate 1 by bonding. However, the present invention is not limited thereto. For example, as shown in FIG. 22, the radiographic imaging element 10A and the radiographic imaging element 10B may be fixed detachably to one face-side of the support substrate 1 by use of fixing members 48. Accordingly, if one or other of the radiographic imaging element 10A and the radiographic imaging element 10B fails, replacement can be made of solely the failed element.

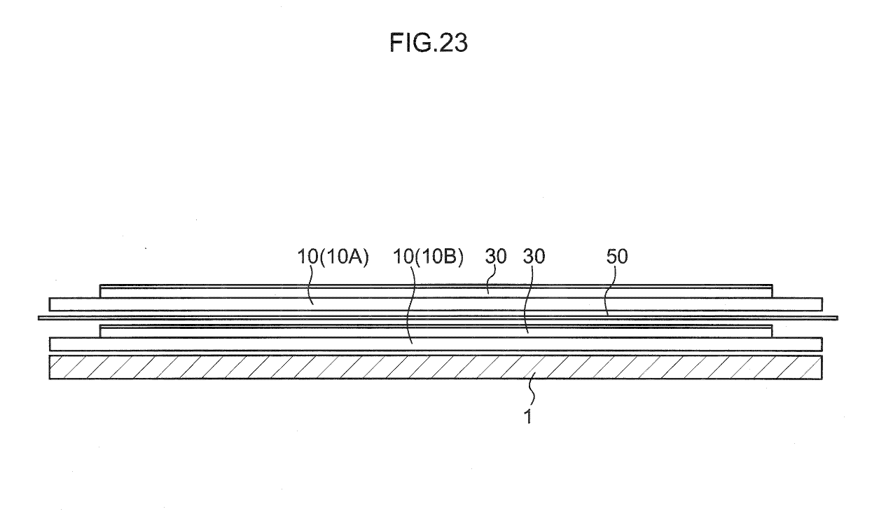

When the absorption of low energy X-rays by the radiographic imaging element 10A is insufficient, or when a greater energy difference is desired for the X-rays imaged by the radiographic imaging elements 10A, 10B, then, as shown in FIG. 23, a filter 50 may be provided between the radiographic imaging element 10A and the radiographic imaging element 10B for absorbing radiation of low energy. By provision of the filter 50, the energy difference between the X-rays imaged by the radiographic imaging elements 10A, 10B can be increased.

The filter 50 can be realized by provision of a thin metal plate. However, the bonding layer can also have a combined use as the energy filter by incorporating a powder, such as titanium oxide (TiO₂), aluminum oxide (Al₂O₃), or the like, into a binder made from a polyurethane resin.

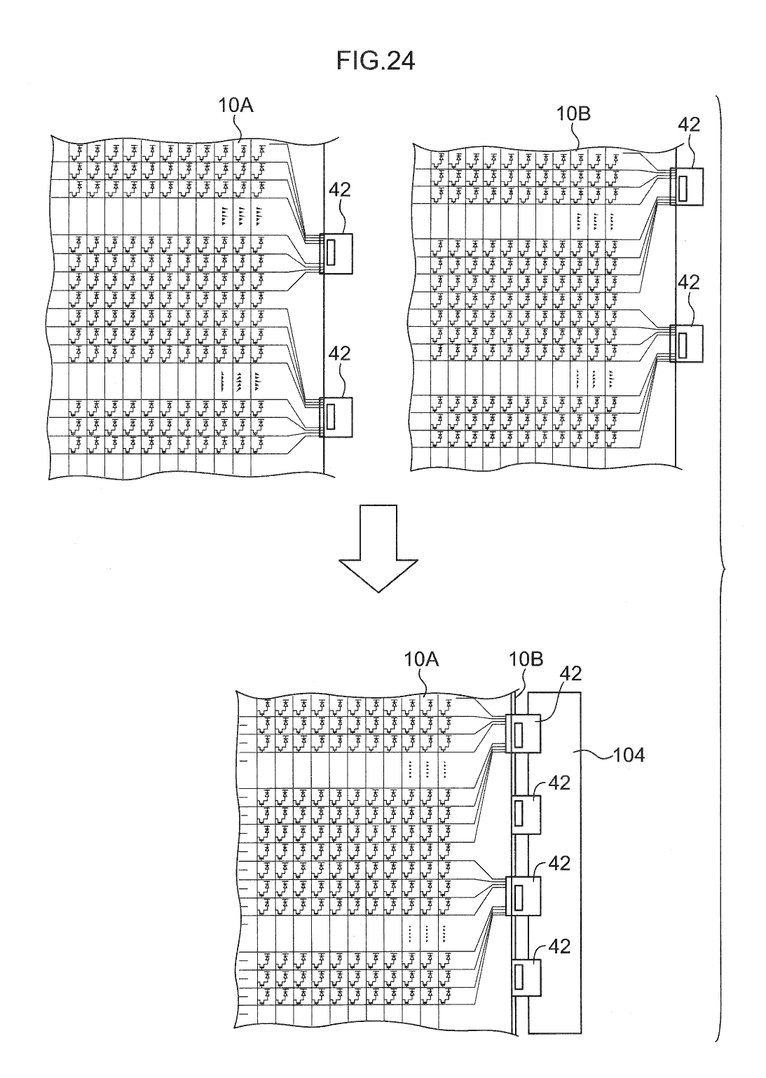

In the first and the third exemplary embodiments above, explanation has been given of cases where the signal detection circuits 105 and the scan signal control circuits 104 are superimposed. However, the present invention is not limited thereto. For example, the connectors 40, 42 may be formed for a given number of the signal lines 3 and a given number of the scan lines 101 in the radiographic imaging elements 10. In addition, the connectors 40, 42 may be provided in positions that are not superimposed when the radiographic imaging element 10A and the radiographic imaging element 10B are layered. An example is shown in FIG. 24 where the connectors 42 of the respective radiographic imaging elements 10A, 10B are provided in non-superimposing positions.

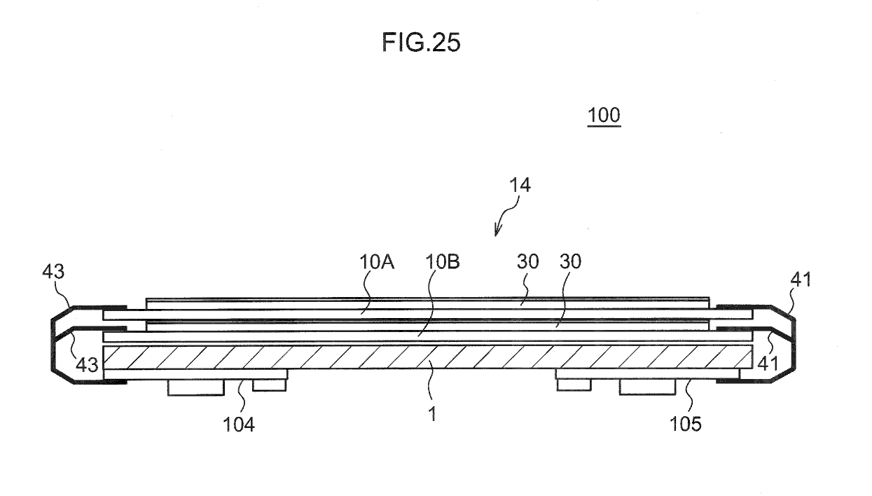

In each of the above exemplary embodiments, explanation has been given of cases where plural of the signal detection circuits 105 and the scan signal control circuits 104 are provided, corresponding to the number of radiographic imaging elements 10. However, the present invention is not limited thereto. For example, as shown in FIG. 25, the radiographic imaging elements 10 may be controlled by a single signal detection circuit 105 and a single scan signal control circuit 104.

In the fourth exemplary embodiment above, explanation has been given of a case in which the exposed regions 44 are provided at two end portions of the radiographic imaging elements 10 in the scan line direction, and both ends are formable with the connectors 42. However, the present invention is not limited thereto. For example, an exposed region where the signal lines 3 are exposed may be provided at both end portions in the signal line direction, with both ends formable with the connectors 40. Thereby, when the signal detection circuits 105 would be superimposed when two of the radiographic imaging elements 10 are layered, the signal detection circuits 105 can be disposed in non-superimposing positions by changing the position of the connectors 40.

The connector may be formable at both end portions of the radiographic imaging element 10 in the scan line direction and in the signal line direction. By so doing, for example, even when both the signal detection circuits 105 and the scan signal control circuits 104 would be superimposed as in the first exemplary embodiment, the signal detection circuits 105 and the scan signal control circuits 104 can be disposed in non-superimposing positions.

In the second exemplary embodiment above, explanation has been given of a case where one of the radiographic imaging elements 10 is rotated by 180° and layered, and in the third exemplary embodiment above of a case where one of the radiographic imaging elements 10 is back-front-reversed and layered, and in the fourth exemplary embodiment above of a case where both end portions of each of the scan lines 101 and both end portions of each of the signal lines 3 of the radiographic imaging element 10 are formable with a connector. However, the radiographic imaging elements 10 may be layered with appropriate combinations of these features.

In each of the above exemplary embodiments, explanation has been given of a case where the signal detection circuits 105 and the scan signal control circuits 104 are provided as a control section 12. However, the present invention is not limited thereto. For example, a combined circuit may be provided with the functions of the signal detection circuit 105 and the scan signal control circuit 104. Provision may also be made of one or other of the signal detection circuit 105 or the scan signal control circuit 104 alone.

In each of the above exemplary embodiments, explanation has been given of a case in which application of the present invention has been made to indirect conversion radiographic imaging elements 10 that first convert radiation into light in the scintillator 30 and then convert the converted light into charge and accumulate the charge in the sensor portion 103. However, the present invention is not limited thereto. For example, application may be made to direct-conversion-type radiographic imaging elements that directly convert radiation into charge and accumulate the converted charge in a sensor portion that utilizes amorphous selenium or the like.

In the above exemplary embodiments, explanation has been given of cases where the same radiographic imaging elements are used for the radiographic imaging elements 10A, 10B. However, the present invention is not limited thereto. For example, radiographic imaging elements may be used that have different array patterns or numbers of the pixels 20, or direct-conversion-type.

In addition the configurations of the radiographic imaging element 10 (see FIG. 1 and FIG. 17) and the configurations of the radiographic imaging device 100 (see FIG. 2 to FIG. 16, and FIG. 18 to FIG. 25) explained in the above exemplary embodiments are only examples, and various appropriate modifications and variations may be made within a scope that does not depart from the spirit of the present invention.

What is claimed is:

1. A radiographic imaging device comprising:
a support body of flat plate shape;
a plurality of radiographic imaging elements disposed layered at one face-side of the support body, each of the radiographic imaging elements detecting radiation irradiated thereon and outputting an image signal that represents a radiographic image according to an amount of the radiation;
a control section, disposed at the opposite face-side of the support body, that performs at least one of control of detection in each of the plurality of radiographic imaging elements, and/or signal processing to the image signal; and
connection lines that connects each of the respective plurality of radiographic imaging elements to the control section.

2. The radiographic imaging device of claim 1, wherein one or more of the plurality of radiographic imaging elements is back-front-reversed and layered.

3. The radiographic imaging device of claim 1, wherein:
the plurality of radiographic imaging elements are each formed in a rectangular plate shape and a connection portion for connecting to the control section is provided at each of two adjacent edges from the four edges of the radiographic imaging element; and
one or more of the plurality of radiographic imaging elements is rotated by 180° in the plane of the flat plate shape.

4. The radiographic imaging device of claim 1, wherein:
the plurality of radiographic imaging elements are each disposed with a plurality of scan lines and a plurality of signal lines that intersect with each other, both ends of the lines are exposed in at least one of the plurality of scan lines and/or the plurality of signal lines; and
connection portions for connecting to the control section are formed at both ends.

5. The radiographic imaging device of claim 1, wherein:
the plurality of radiographic imaging elements are each disposed with a plurality of scan lines and a plurality of signal lines that intersect with each other; and
a connection portion for connection to the control section is provided to at least one of the plurality of scan lines and/or the plurality of signal lines at a position that is not superimposed when the plurality of radiographic imaging elements are layered.

6. The radiographic imaging device of claim 1, wherein:
a plurality of the control sections are provided corresponding to the plurality of radiographic imaging elements; and
each of the control sections is connected through the connection lines to the corresponding radiographic imaging element.

7. The radiographic imaging device of claim 6, wherein:
the connection lines are formed by a flexible printed substrate;
the control section is provided on one face-side with a connector for connecting the connection lines; and
the control section(s) that correspond to the layered back-front-reversed radiographic imaging element(s) are disposed back-front-reversed.

8. The radiographic imaging device of claim 1, wherein:
the connection lines are formed by a flexible printed substrate; and
the control section is provided on both front and back faces with a connector for connecting the connection lines.

9. The radiographic imaging device of claim 1, wherein the control section is provided on both front and back faces with an output terminal for outputting an image signal after the signal processing.

10. The radiographic imaging device of claim 1, wherein the control section is fixed directly to the support body or is fixed indirectly to the support body by a support member.

11. The radiographic imaging device of claim 1, wherein each of the plurality of radiographic imaging elements is provided with a bonding layer on the face at the support body side or on the face at the side of another radiographic imaging element, and is fixed to one face of the support body by bonding.

12. The radiographic imaging device of claim 1, wherein the plurality of radiographic imaging elements are detachably fixed to one face-side of the support body by a fixing member.

13. The radiographic imaging device of claim 1, further comprising a filter that absorbs radiation and is interposed between the plurality of radiographic imaging elements.

14. The radiographic imaging device of claim 13, wherein the filter is fixed to one or other of the radiographic imaging elements the filter makes contact with.

15. The radiographic imaging device of claim 1, wherein each of the radiographic imaging elements comprises:
a light generation section that generates light according to the radiation irradiated thereon;
a sensor section that generates charge according to illumination thereon of light generated by the light generation section; and
a light blocking body that blocks light generated by the light generation section and is provided on the opposite face-side of the radiographic imaging element.

16. The radiographic imaging device of claim 15, wherein the light blocking body is configured by a light generation section support body that supports the light generation section.

17. The radiographic imaging device of claim 1, wherein the plurality of radiographic imaging elements have the same array pattern of pixel portions that detect radiation as data, for pixels configuring each respective radiographic image.
